(19) United States
(12) Patent Application Publication
(10) Pub. No.: US 2011/0299588 A1
(43) Pub. Date: Dec. 8, 2011

(54) RATE CONTROL IN VIDEO COMMUNICATION VIA VIRTUAL TRANSMISSION BUFFER

(75) Inventors: Xiaosong ZHOU, Campbell, CA (US); Hsi-Jung WU, San Jose, CA (US)

(73) Assignee: APPLE INC., Cupertino, CA (US)

(21) Appl. No.: 12/882,522

(22) Filed: Sep. 15, 2010

Related U.S. Application Data
(60) Provisional application No. 61/351,778, filed on Jun. 4, 2010.

(51) Int. Cl. H04N 7/26

(52) U.S. Cl. 375/240.02; 375/E07.076

(57) ABSTRACT

Embodiments of the present invention provide a video encoding system that may include a coding engine to code an input video signal according to a video compression process, compression of each portion of the input signal performed according to coding parameters assigned to the respective portion. The video encoding system may also include a rate controller to select coding parameters of each portion of the input signal, the rate controller estimating delay of delivery of coded video data by a delivery network according to a leaky bucket modeling process and selecting coding parameters of a portion to be coded based at least in part on the estimated delay.

### CROSS REFERENCE TO RELATED APPLICATIONS

The present application claims the benefit of US Provisional application, Ser. No. 61/351,778, filed Jun. 4, 2010, entitled “RATE CONTROL IN VIDEO COMMUNICATION VIA VIRTUAL TRANSMISSION BUFFER,” the disclosure of which is incorporated herein by reference in its entirety.

### FIELD OF THE INVENTION

The present invention is directed to video processing techniques and devices. In particular, the present invention is directed to rate control systems in video coders responsive to communication channel conditions.

### BACKGROUND

In a video coding system, video streams usually are compressed on a frame-by-frame basis at variable bit rates (VBR). That is, the number of bits used to code each frame often varies based on image content and coding parameter selections made during coding, such as coding modes (e.g., I-coding, P-coding, or B-coding). More bits can be “spent” to code difficult frames or segments to maintain a generally constant visual quality throughout the stream when it is recovered at a decoder.

The coded bit stream is transmitted to the decoder over a communication channel. Communication channel conditions can affect the operations of the video encoding system. For example, the communication channel may have a limited available bandwidth that can affect the quality of the video communication system because when the encoder bit rate exceeds the available bandwidth of the communication network, delays or packet losses may be introduced into the video communication system. Also, communication channel conditions may be unstable and may vary in time according to external factors such as number of active users in the network or signal strength in the case of wireless networks. As a result, communication channel conditions can adversely affect video encoding system by introducing delays or packet losses.

Moreover, real-time video communication systems such as video chatting are gaining popularity. Real-time video communication systems rely heavily on the communication network conditions in order to facilitate real-time video communication. If network conditions deteriorate, video signals can be lost, which can be frustrating to the user.

Conventional video coding systems do not take into account the conditions of the communication channel when coding the video signals. The inventors of the present invention discovered that coding techniques can be used to mitigate various communication channel conditions. Accordingly, they identified a need in the art for adjusting coding parameters based on channel conditions thus facilitating stable video communication systems.

### BRIEF DESCRIPTION OF THE DRAWINGS

FIG. 1 is a simplified block diagram of an exemplary encoding system according to an embodiment of the present invention.

FIG. 2 is a simplified diagram of “leaky bucket” model according to an embodiment of the present invention.

FIG. 3 is a flow diagram of a coding technique according to an embodiment of the present invention.

FIG. 4 is a simplified block diagram of an exemplary encoding system according to an embodiment of the present invention.

FIG. 5(a) is a flow diagram of a coding technique according to an embodiment of the present invention.

FIG. 5(b) a flow diagram of a coding technique according to an embodiment of the present invention.

FIG. 6 is an example embodiment of a particular hardware implementation of the present invention.

### DETAILED DESCRIPTION

Embodiments of the present invention provide a video encoding system that may include a coding engine to code an input video signal according to a video compression process, compression of each portion of the input signal performed according to coding parameters assigned to the respective portion. The video encoding system may also include a rate controller to select coding parameters of each portion of the input signal, the rate controller estimating delay of delivery of coded video data by a delivery network according to a leaky bucket modeling process and selecting coding parameters of a portion to be coded based at least in part on the estimated delay.

Embodiments of the present invention provide a method of controlling an encoder bit rate in a variable bit rate encoder. The method may include receiving a video signal to be encoded; calculating a delay period based on a leaky bucket modeling process in which an encoder output bit rate is a bucket input rate and an estimated delivery rate of a communication network is a bucket output rate; assigning coding parameters to a portion of the input video data based at least in part on the calculated delay period; and coding the portion according to a bandwidth compression coding process using the assigned coding parameters.

Embodiments of the present invention provide a computer-readable storage medium encoded with program instructions that, when executed by a processor, cause the processor to responsive to receiving a input video signal, estimating network delay according to a leaky bucket modeling process based on a current coding rate and an estimated delivery rate of a communication channel; adjusting a current coding rate according to bucket fullness; and coding the input video signal into a compressed bitstream at the adjusted coding rate.

The method may include, responsive to receiving the input video signal, calculating a network delay period based on an input rate and an output rate of a communication channel, wherein the input rate is the encoder's bit rate; adjusting the encoder bit rate according to the network delay period; and coding the input video signal into the compressed bitstream at the adjusted encoder bit rate.

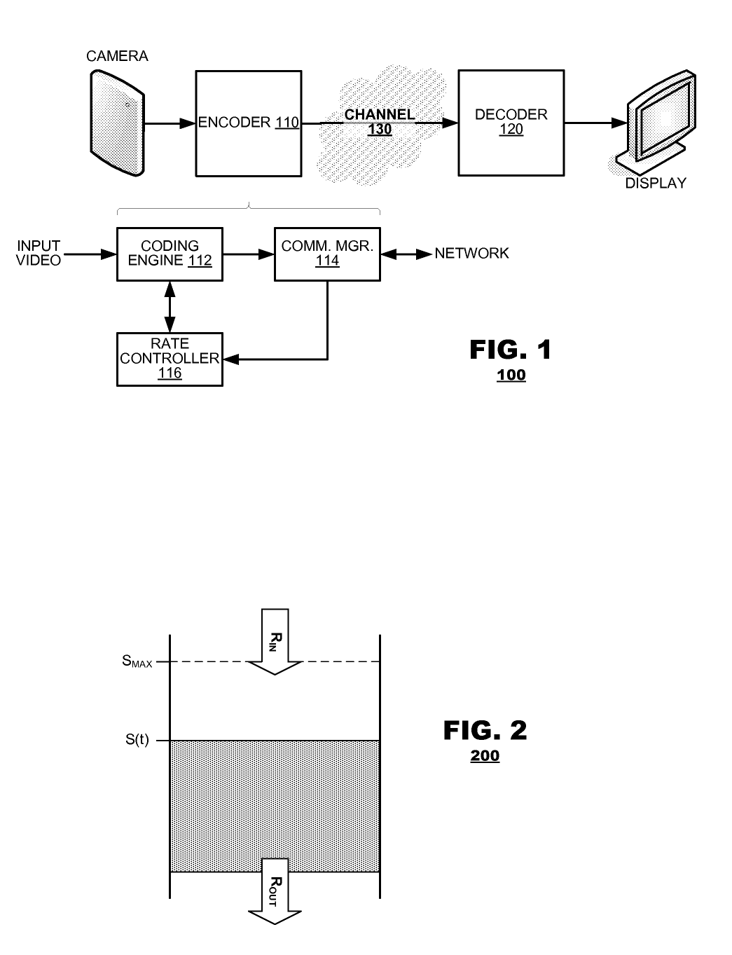

FIG. 1 illustrates a block diagram of a coding system 100 in which the present invention may be employed. System 100 may include a video source device, such as a camera, that includes or is coupled to an encoder 110. The encoder 110 may be communicatively coupled to a decoder 120 via a communication channel 130. The decoder 120 may include or be coupled to an output device, such as a display.

The video source device may be a video capturing device such as a camera, a synthetic image generator, or any suitable video generating device. Alternatively, the video source device may be a storage device that stores image data from an image source. The encoder 110 may perform bandwidth compression on an input video signal from the image source. The encoder 110 may output the coded video data to a channel 130.

The channel 130 represents a communication link between the encoder 110 and decoder 120. The channel may be provided by one or more networks, such as communication and/or computer networks. The channel 130 may be provided in a wired communication network (e.g., by physical fiber optical or electrical channels), may be provided in a wireless communication network (e.g., by cellular or satellite communication channels) or by a combination thereof. Communication conditions (e.g. bandwidth, delay) of the channel 130 may change dynamically, and packets may be lost or delayed in transmission.

The decoder 120 may generate a recovered video signal that is a replica of the input video signal coded by the encoder 110. The recovered video signal may be transmitted to an output device. The output device may be a display device to render the recovered video signal or a storage device for later rendering.

FIG. 1 also illustrates a simplified block diagram of the encoder 110 according to an embodiment of the present invention. The encoder 110 may include a coding engine 112, a communication manager 114, and a rate controller 116. The coding engine 112 may receive the input video signal and may perform bandwidth compression operations on the input video signal to generated coded video data. For example, the coding engine 112 may perform predictive coding operations, according to the well known H.264, H.263 and/or MPEG coding protocols. The coding engine 112 also may perform pre-processing operations (not shown) prior to conditioning the input signal for coding. After performing coding operations, the coding engine 112 may output the coded video data to the communication manager 114.

The communication manager 114 may deliver the coded video data to the channel 130 in an appropriate format for transmission in the network. For example, the communication manager 114 may encode the coded video data packets for delivery over a TCP/IP network or may modulate the coded video data packets for delivery over wireless communication network.

The rate controller 116 may be coupled to both the coding engine 112 and communication manager 114. The rate controller 116 may manage the operations of the coding 112 based on information provided by the coding engine 112 and communication manager 114. The rate controller 116, for example, may establish target bit rates for the coded video data output by the coding engine 112. The rate controller 116 may establish target bit rates for coded video data based on estimates of transmission delays induced by the network, as further described below.

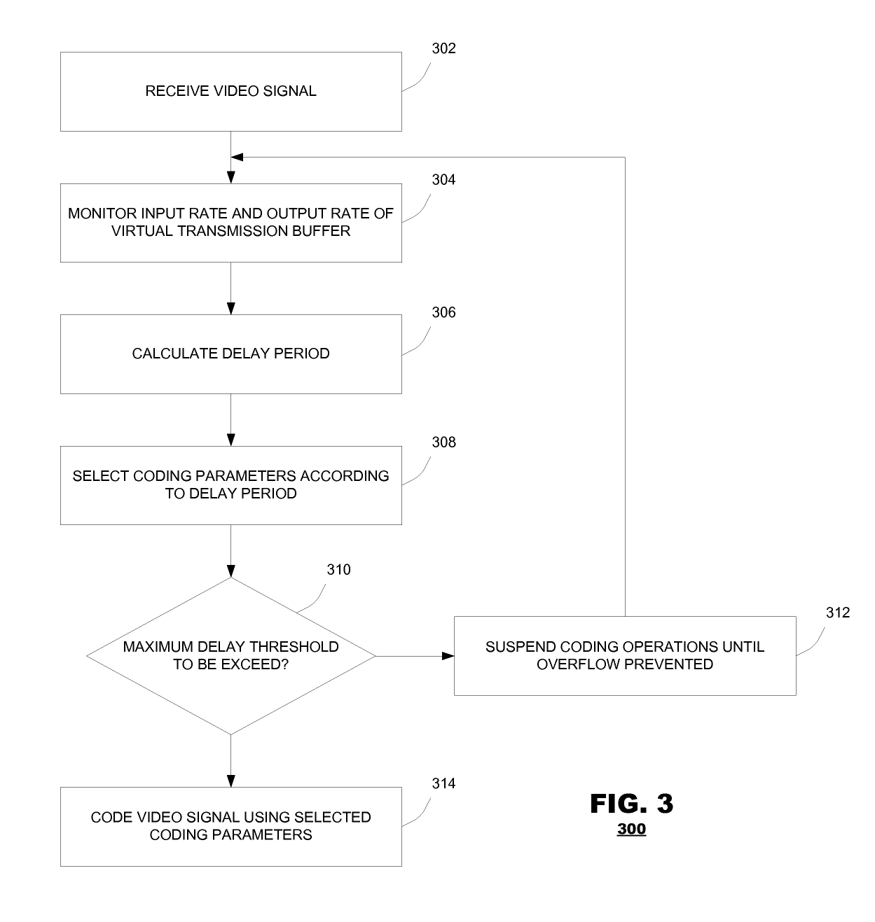

According to an embodiment of the invention, the rate controller 116 may model performance of the channel using a virtual buffer model, shown in FIG. 2 that operates as a “leaky bucket.” The virtual buffer may emulate performance of the network. As shown in FIG. 2, the virtual buffer 200 is illustrated as receiving input data at a rate R_{IN} and draining data at an output rate R_{OUT}. R_{IN} may correlate to the bit rate at which the encoder outputs data to the network, and R_{OUT} may correlate to the network output rate to the decoder. Thus, R_{OUT} may correspond to a detected bandwidth or target bit rate, which can change during a communication session. As such, the virtual buffer may effectively model the network traffic and delays associated therewith.

The maximum delay in the bucket D_{MAX} may be decided by the size of the bucket (S_{MAX}), which is a configurable parameter. The maximum delay D_{MAX} may be equal to S_{MAX}/R_{OUT}. S_{MAX} may be selected based on a need to accommodate VBR video with acceptable quality, and the delay to provide acceptable user experience under different scenarios. Assuming encoder 110 generates frames with acceptable quality and with average frame size L, S_{MAX} should be big enough to hold a predetermined amount (N*L) of coded frames such that variations in frame size can be accommodated. The buffer 200 may store a quantity of data based on differences in the input rate R_{IN} and output rate R_{OUT} represented by S(t). Thus, S(t) may represent the amount of data in the bucket. The input rate R_{IN} and output rate R_{OUT} may vary during operations of the encoder and channel, as discussed below, and therefore S(t) typically will vary over time.

Given an amount of data stored in the virtual buffer S(t) and a drain rate of the buffer R_{OUT}, the virtual buffer may impose a delay on data given by Eq. (1) below:

$$D ( t ) = \frac{S ( t )}{{R}_{OUT}} , \qquad ( 1. )$$

where D(t) represents the instantaneous delay, S(t) is amount of data stored in the virtual buffer, and R_{OUT} is output rate of the virtual buffer. R_{OUT} will vary during a communication session but is updated at a slower rate than R_{IN} and S(t). Therefore, R_{OUT} in Eq. 1 is shown as a constant; however, a time-varying R_{OUT} can be accommodated as well.

In an embodiment, the rate controller 116 may control the code engine 112 to keep generating encoded frames as long as they fit into the bucket, and may suspend operations until enough room is being created as described below. Accordingly, the rate controller 116 may select or change coding parameters, assuming acceptable quality metrics can be met, to reduce the buffer size S(t) and keep the delay period D(t) as low as possible.

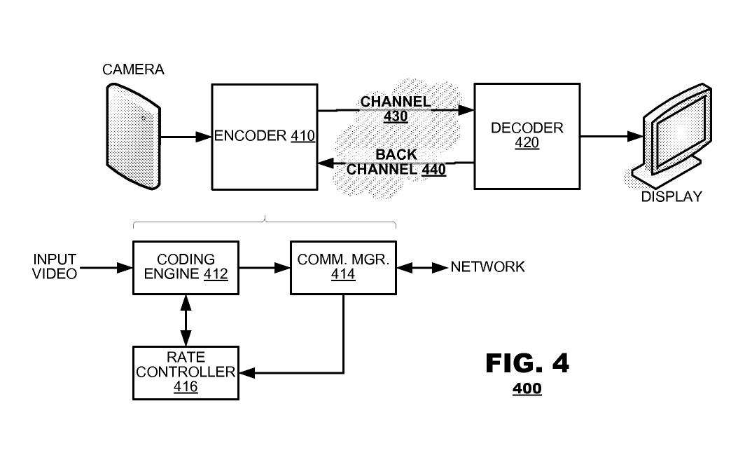

FIG. 3 illustrates a simplified flow diagram of an encoder operation method 300 according to an embodiment of the present invention. The encoder 110 may receive an input video signal (step 302). The encoder may then monitor the input rate R_{IN} and output rate R_{OUT} of the virtual buffer that models the coupled communication channel 130 (step 304).

The input data rate R_{IN}(t) may be derived from estimated sizes of coded frames based on a set of coding parameters. As described, many encoding processes are variable bit rate processes. Although encoders typically code input video at a consistent frame rate, they may generate coded video data whose bits/frame vary based on several factors including, complexity of the image content at each frame, a coding mode selected for each frame (e.g., inter vs. intra-frame techniques), differences between the frames (motion), and parameter selections. Thus, the number of bits per frame may be expected to vary over time, which causes the buffer input rate (R_{IN}(t)) to vary accordingly.

After receiving the virtual transmission buffer conditions, the rate controller 116 may calculate a delay period, D(t) from current monitored buffer conditions (step 306). The rate controller 116 may then select coding parameters based on the delay period, D(t), plus buffer fullness (step 308). For example, when the rate controller 116 determines that the buffer is generally full, the rate controller 116 may revise its bit rate budget downward to reduce R_{IN}. When the buffer is generally empty, the rate controller 116 may revise its bit rate budget to allow for higher quality coding by the encoder, which generally increases R_{IN}. For example, the rate controller may adjust quantization parameters and/or coding modes for frame pixel blocks to revise the bit rate of coded video data.

The output rate R_{OUT} may be derived from channel statistics provided by a communication manager 114 indicating throughput of the channel. The communication manager 114 may collect transmission data, such as number of NACKs received, latency, packet loss information, confidence interval of the estimated parameters, an amount of time between receiving NACKs, an amount of time the codec has been in a specific mode, feed back from the receiver end and the like. The communication manager 114 may generate and maintain statistics based on the collected transmission data, for example, based on packet timestamps. In addition, the communication manager 114 may also provide additional transmission data, such as indications of transmission errors, or the network may provide error information, or any other error detection scheme built into an application layer.

In another embodiment, the rate controller 116 may estimate rates of change in network delay (ΔD), which may be determined as:

$$Δ D = \frac{S ( {t}_{2} ) - S ( {t}_{1} )}{{R}_{OUT}} , \qquad ( 2. )$$

where S(t₁) represents the buffer size at a first time t₁ and S(t₂) represents the buffer size at a second time t₂. In such an embodiment, the rate controller 116 may select coding parameters for input video data that are based at least in part the change in delay (ΔD) that would be induced by those coding selections. It may select coding parameters that minimize ΔD.

In such an embodiment, the rate controller 116, after receiving the virtual transmission buffer conditions, may calculate a the change in delay ΔD from current monitored buffer conditions (step 306). The rate controller 116 may then select coding parameters based on the delay period, ΔD, plus buffer fullness (step 308).

Also, the rate controller 116 may configure to encoder to code input video at a desired level of coding quality. The input video signal may have a minimum coding quality requirement for all coded data. When coding a new frame, if the rate controller estimates that several different coding configurations each would result in a coded video frame of acceptable quality, the rate controller may consider the fullness of the virtual buffer to select a coding configuration that minimizes transmission delay.

After selecting the coding parameters, the rate controller 116 may estimate the effect on the virtual transmission buffer with regards to the expected delay period D(t). The rate controller may compare the expected delay D(t) to a maximum delay that is permissible for coding (D_{MAX}) (step 310). In implementation, the maximum delay threshold D_{MAX} may be modeled as a maximum buffer size threshold, shown as S_{MAX}.

If the rate controller 116 selects coding parameters that would cause the maximum delay threshold to be exceeded, the rate controller 116 may suspend coding operations for the input video signal until the buffer is drained sufficiently to prevent overflow (step 312). After overflow is prevented, the encoder may resume operations with respect to the input video signal by returning to monitoring the input and output rates of the virtual transmission buffer (step 304) and continue the encoder operation from that step. Alternatively, after overflow is prevented, the encoder may return to any previous step of the encoder operation method 300.

If the rate controller 116 selects coding parameters that would not cause the maximum delay threshold to be exceeded, the coding engine 112 may code the input video signal into coded video data using the selecting coding parameters (step 314). The coded video data signal may then be transmitted over the communication channel 130 to the decoder 120, where the coded signal may be decoded to produce a replica of the video signal and be outputted to an output device.

In another embodiment of the present invention, the rate controller 116 may revise the frame rate of coding rather than target bits per frame. When the rate controller detects that D(t) is increasing, the rate controller initially may reduce the target bits per frame. It also may estimate the image quality that will be obtained from the target bit rate and, if the quality falls below a predetermined threshold, it may revise the frame rate instead and increase the target number of bits per frame to allow for higher quality image coding, albeit at a lower frame rate.

In another embodiment, the rate controller 116 may vary the size of the buffer threshold S_{MAX} based on frame rate currently in use and by coding assignments made to each frame. For example, an I-coded frame is expected to have more bits than the same frame coded according to P-coding or B-coding techniques. Thus, for a given frame rate, the buffer threshold S_{MAX} may vary based on coding decisions made to input video frames. Alternatively, the buffer threshold S_{MAX} may be set according to expected numbers of I-coding, P-coding and B-coding mode decisions to be made by an encoder. If the frame rate is modified, the S_{MAX} threshold may be modified as well; for example, if the frame rate is lowered, S_{MAX} may be increased accordingly. S_{MAX} may also be modified when R_{OUT} changes. For example, if R_{OUT} increases, S_{MAX} may be increased accordingly.

In the above described embodiments, network delays and output rate R_{OUT} were estimated from channel statistics provided by the communication manager 114 and the “leaky bucket” model described with respect to FIG. 2 above. In another embodiment of the present invention, the encoder may estimate network delay from different sources and use the information from different sources in order to select optimum coding parameters.

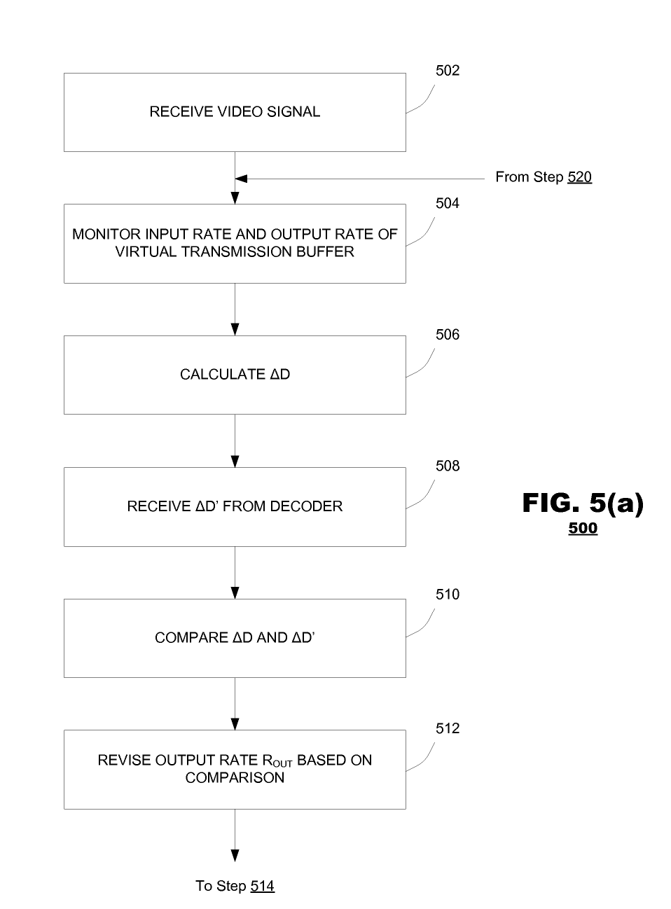

FIG. 4 illustrates a block diagram of a coding system 400 with a back channel in which the present invention may be employed. System 400 may include a video source device, such as a camera, that includes or is coupled to an encoder 410. The encoder 410 may be communicatively coupled to a decoder 420 via a communication channel 430. The decoder 420 may include or be coupled to an output device, such as a display. The decoder may also be communicatively coupled to the encoder via a backchannel 440.

The video source device may be a video capturing device such as a camera, a synthetic image generator, or any suitable video generating device. Alternatively, the video source device may be a storage device that stores image data from an image source. The encoder 410 may perform bandwidth compression on an input video signal from the image source. The encoder 410 may output the coded video data to a channel 430.

The channel 430 represents a communication link between the encoder 410 and decoder 420. The channel may be provided by one or more networks, such as communication and/or computer networks. The channel 430 may be provided in a wired communication network (e.g., by fiber optical or electrical physical channels), may be provided in a wireless communication network (e.g., by cellular or satellite communication channels) or by a combination thereof. Communication conditions (e.g. bandwidth, delay) of the channel 430 may change dynamically, and packets may be lost or delayed in transmission.

The decoder 420 may generate a recovered video signal that is a replica of the input video signal coded by the encoder 410. The recovered video signal may be transmitted to an output device. The output device may be a display device to render the recovered video signal or a storage device for later rendering.

The system 400 may also in include a back channel 440 in which the decoder 420 may communicate information to the encoder 410. In an embodiment of the present invention, the decoder 420 may estimate network delay period D′(t) of packets delivered by the network. The decoder 420 may then report the delay estimates to the encoder 410 via the back channel 440.

FIG. 4 also illustrates a simplified block diagram of the encoder 410 according to an embodiment of the present invention. The encoder 410 may include a coding engine 412, a communication manager 414, and a rate controller 416. The coding engine 412 may receive the input video signal and may perform bandwidth compression operations on the input video signal to generated coded video data. For example, the coding engine 412 may perform predictive coding operations, according to the well known H.264, H.263 and/or MPEG coding protocols. The coding engine 412 also may perform pre-processing operations (not shown) prior to conditioning the input signal for coding. After performing coding operations, the coding engine 412 may output the coded video data to the communication manager 414.

The communication manager 414 may deliver the coded video data to the channel 430 in an appropriate format for transmission in the network. For example, the communication manager 414 may encode the coded video data packets for delivery over a TCP/IP network or may modulate the coded video data packets for delivery over wireless communication network. The communication manager 414 may also receive delay reports indicative of channel 430 conditions from the decoder 414 via the backchannel 440.

The rate controller 416 may be coupled to both the coding engine 412 and communication manager 414. The rate controller 416 may manage the operations of the coding 412 based on information provided by the coding engine 412 and communication manager 414. The rate controller 416, for example, may establish target bit rates for the coded video data output by the coding engine 412. The rate controller 416 may establish target bit rates for coded video data based on estimates of transmission delays induced by the network, as further described below.

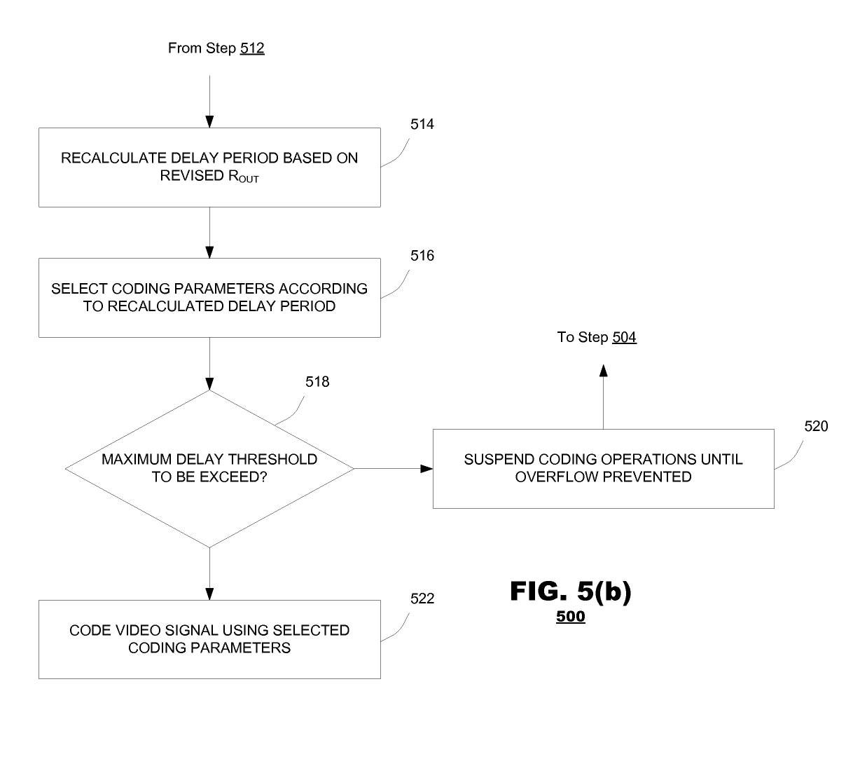

FIGS. 5(a) and 5(b) illustrate a simplified flow diagram of an encoder operation method 500 according to an embodiment of the present invention. The encoder may receive an input video signal (step 502). The encoder may then monitor the input rate R_{IN} and output rate R_{OUT} of the virtual buffer that models the coupled communication channel (step 504).

The input data rate R_{IN}(t) may be derived from estimated sizes of coded frames based on a set of coding parameters. As described, many encoding processes are variable bit rate processes. Although encoders typically code input video at a consistent frame rate, they may generate coded video data whose bits/frame vary based on several factors including, complexity of the image content at each frame, a coding mode selected for each frame (e.g., inter vs. intra-frame techniques), differences between the frames (motion), and parameter selections. Thus, the number of bits per frame may be expected to vary over time, which causes the buffer input rate (R_{IN}(t)) to vary accordingly.

The output rate R_{OUT} may be derived from channel statistics provided by a communication manager 414 indicating throughput of the channel. The communication manager 114 may collect transmission data, such as number of NACKs received, latency, packet loss information, confidence interval of the estimated parameters, an amount of time between receiving NACKs, an amount of time the codec has been in a specific mode, feed back from the receiver end and the like. The communication manager 114 may generate and maintain statistics based on the collected transmission data, for example, based on packet timestamps. In addition, the communication manager 114 may also provide additional transmission data, such as indications of transmission errors, or the network may provide error information, or any other error detection scheme built into an application layer.

After receiving the virtual transmission buffer conditions, the rate controller 116 may calculate a first delay period ΔD as shown in Eq. 2 above (step 506). A second delay estimate ΔD′ may be derived from delay reports delivered by the decoder (labeled, D′(t) for convenience) (step 508). The two delay estimate values, ΔD and ΔD′, may be compared to each other (step 510). The comparison of the relative values of ΔD and ΔD′ may indicate whether the “leaky bucket” model provides an appropriate guide for selection of coding parameters.

Generally, the rate controller's estimate of R_{OUT} may be a coarse estimate of channel bandwidth that is obtained from channel 430 characteristics estimated by a communications manager 414. A communications manager 414 may engage in protocols to estimate channel bandwidth directly but such protocols can interfere with run-time operation of the encoder. For example, some protocols may cause the communications manager 414 to enter an offline mode in which no coded video may be transmitted. Accordingly, it may be disadvantageous to perform direct estimates of channel bandwidth at a high rate.

In such an embodiment, the rate controller 416 may use ΔD and ΔD′ calculations to revise R_{OUT} estimates without engaging invasive channel estimation protocols (step 512). The rate controller may compare the ΔD and ΔD′ protocols to each other to determine whether a current R_{OUT} estimate should be revised. Table 1 illustrates exemplary operation of the rate controller in response to such comparisons:

TABLE 1

| ΔD | ΔD′ | SYSTEM REACTION |
|---|---|---|
| + | + | Compare magnitudes of ΔD and ΔD′. |
| | | If \|ΔD′\| >> \|ΔD\|, revise R_{OUT} estimate lower. |
| | | If \|ΔD′\| << \|ΔD\|, revise R_{OUT} estimate higher. |
| + | − | Revise R_{OUT} estimate higher. |
| − | + | Revise R_{OUT} estimate lower. |
| − | − | Compare magnitudes of ΔD and ΔD′. |
| | | If \|ΔD′\| >> \|ΔD\|, revise R_{OUT} estimate higher. |
| | | If \|ΔD′\| << \|ΔD\|, revise R_{OUT} estimate lower. |

After revising the output rate R_{OUT}, the rate controller 416 may re-calculate a delay period, D(t), which is also the rate of change in the buffer size, from the monitored buffer conditions based on the revised R_{OUT} (step 514). The rate controller 116 may select coding parameters based on the re-calculated delay period, D(t) (step 516). For example, when the rate controller 116 determines that the buffer size is increasing (D(t)) over a period of time, the rate controller may revise its bit rate budget downward to counteract the increasing buffer size. When the buffer size is decreasing (D(t) is decreasing), a rate controller may revise its bit rate budget to allow for higher quality coding by the encoder.

Also, the rate controller 416 may configure to encoder to code input video at a desired level of coding quality. The input video signal may have a minimum coding quality requirement. When coding a new frame, if the rate controller estimates that several different coding configurations each would result in a coded video frame of acceptable quality, the rate controller may consider the fullness of the virtual buffer to select a coding configuration that minimizes transmission delay.

After selecting the coding parameters, the rate controller 116 may estimate the affect on the virtual transmission buffer with regards to the expected delay period D(t). The rate controller may compare the expected delay D(t) to a maximum delay that is permissible for coding (D_{MAX}) (step 518). In implementation, the maximum delay threshold D_{MAX} may be modeled as a maximum buffer size threshold, shown as Sₘₘ.

If the rate controller selects coding parameters that would cause the maximum delay threshold to be exceeded, the rate controller may suspend coding operations for the input video signal until the buffer is drained sufficiently to prevent overflow (step 520). After overflow is prevented, the encoder may resume operations with respect to the input video signal by returning to monitoring the input and output rates of the virtual transmission buffer (step 504) and continue the encoder operation from that step. Alternatively, after overflow is prevented, the encoder may return to any previous step of the encoder operation.

If the rate controller selects coding parameters that would not cause the maximum delay threshold to be exceeded, the coding engine 412 may code the input video signal into coded video data using the selecting coding parameters (step 522). The coded video data signal may then be transmitted over the communication channel 430 to the decoder 420, where the coded signal may be decoded to produce a replica of the video signal and be outputted to an output device.

In another embodiment of the present invention, the rate controller 416 may revise the frame rate of coding rather than target bits per frame. When the rate controller detects that D(t) is increasing, the rate controller initially may reduce the target bits per frame. It also may estimate the image quality that will be obtained from the target bit rate and, if the quality falls below a predetermined threshold, it may revise the frame rate instead and increase the target number of bits per frame to allow for higher quality image coding, albeit at a lower frame rate.

In another embodiment, the rate controller 416 may vary the size of the buffer threshold S_{MAX} based on frame rate currently in use and by coding assignments made to each frame. For example, an I-coded frame is expected to have more bits than the same frame coded according to P-coding or B-coding techniques. Thus, for a given frame rate, the buffer threshold S_{MAX} may vary based on coding decisions made to input video frames. Alternatively, the buffer threshold S_{MAX} may be set according to expected numbers of I-coding, P-coding and B-coding mode decisions to be made by an encoder. If the frame rate is modified, the S_{MAX} threshold may be modified as well; for example, if the frame rate is lowered, S_{MAX} may be increased accordingly.

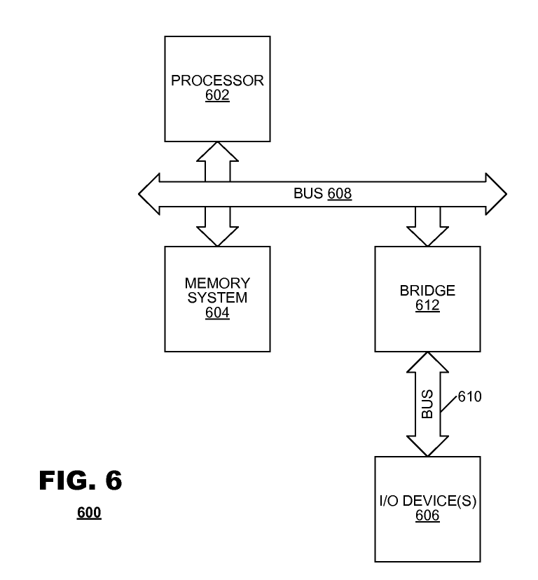

FIG. 6 is a simplified functional block diagram of a computer system 600 in which the present invention may be employed. A coder and decoder of the present invention can be implemented in hardware, software or some combination thereof. The coder and or decoder may be encoded on a computer readable medium, which may be read by the computer system of 600. For example, an encoder and/or decoder of the present invention can be implemented using a computer system.

As shown in FIG. 6, the computer system 600 includes a processor 602, a memory system 604 and one or more input/output (I/O) devices 606 in communication by a communication ‘fabric.’ The communication fabric can be implemented in a variety of ways and may include one or more computer buses 608, 610 and/or bridge devices 612 as shown in FIG. 6. The I/O devices 606 can include network adapters and/or mass storage devices from which the computer system 600 can receive compressed video data for decoding by the processor 602 when the computer system 600 operates as a decoder. Alternatively, the computer system 600 can receive source video data for encoding by the processor 602 when the computer system 500 operates as a coder.

In implementation, the encoders and/or decoders may be embodied as hardware systems, in which case, the blocks illustrated in FIGS. 1 and 4 may correspond to circuit sub-systems within larger system components. Alternatively, the encoders and/or decoders may be embodied as software systems, in which case, the blocks illustrated may correspond to program modules within respective software programs. In yet another embodiment, the encoders and/or decoders may be embodied as hybrid systems involving both hardware circuit systems and software programs. For example, the coding engine may be provided as an application-specific integrated circuit while the rate controller may be provided as software modules. And, since the encoders and decoders may be interoperable according to a predetermined coding protocol, the encoder may have a different architecture from the decoder (e.g., one may be a hardware-based system and the other may be a software-based system). As such, the principles of the present invention find application in a variety of consumer devices, such as personal computers, laptop computers, tablet computers, personal digital assistants, mobile phones, media players and the like.

Those skilled in the art may appreciate from the foregoing description that the present invention may be implemented in a variety of forms, and that the various embodiments may be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims.

We claim:

1. A video encoding system, comprising:
a coding engine to code an input video signal according to a video compression process, compression of each portion of the input signal performed according to coding parameters assigned to the respective portion; and
a rate controller to select coding parameters of each portion of the input signal, the rate controller estimating delay of delivery of coded video data by a delivery network according to a leaky bucket modeling process and selecting coding parameters of a portion to be coded based at least in part on the estimated delay.

2. The system of claim 1, further comprising a communications manager to estimate network conditions.

3. The system of claim 1, wherein the delay is an estimate rate of change in network delay.

4. The system of claim 1, wherein the leaky bucket modeling process comprises comparing an input data rate, represented by a bit rate of coded data output by the coding engine, to an output data rate represented by an estimated delivery rate of the delivery network.

5. The system of claim 1, wherein the code parameters are further selected based on an estimated coding quality of the coded video data.

6. The system of claim 1, wherein the selected code parameters are selected based on a revised target bits per frame of coded data.

7. The system of claim 1, wherein the selected code parameters are selected based on a revised frame rate of coded data.

8. A method of controlling an encoder bit rate in a variable bit rate encoder, comprising:
receiving a video signal to be encoded;
calculating a delay period based on a leaky bucket modeling process in which an encoder output bit rate is a bucket input rate and an estimated delivery rate of a communication network is a bucket output rate;
assigning coding parameters to a portion of the input video data based at least in part on the calculated delay period; and
coding the portion according to a bandwidth compression coding process using the assigned coding parameters.

9. The method of claim 8, further comprising, when a currently-assigned coding parameters causes a fullness threshold to be exceeded, suspending encoder operation until its operation would no longer cause the fullness threshold to be exceeded.

10. The method of claim 8, wherein the delay period is an estimated rate of change in network delay.

11. The method of claim 8, wherein the communication channel rate is derived from channel statistics.

12. The method of claim 8, wherein the encoder bit rate is derived from estimated sizes of coded frames based on a set of coding parameters.

13. The method of claim 8, wherein the selected code parameters support a minimum threshold of quality level of the input video signal.

14. The method of claim 8, wherein the selected code parameters affect target bits per frame.

15. The method of claim 8, wherein the selected code parameters affect a frame rate.

16. The method of claim 8, wherein the assigning comprises selecting one set of coding parameters from a plurality of sets of coding parameters that, if applied to input video, would induce coding at an acceptable coding quality, the selected set achieving a lowest coding bit rate among the plurality of sets.

17. A computer-readable storage medium encoded with program instructions that, when executed by a processor, cause the processor to:
responsive to receiving a input video signal, estimating network delay according to a leaky bucket modeling process based on a current coding rate and an estimated delivery rate of a communication channel;
adjusting a current coding rate according to bucket fullness; and
coding the input video signal into a compressed bitstream at the adjusted coding rate.

18. The computer-readable storage medium of claim 17, further comprising:
determining whether a current coding rate would cause a maximum bucket fullness threshold to be exceeded:
if so, suspending coding operation until the bucket drains sufficiently to allow coding to restart without exceeding the fullness.

19. The computer-readable storage medium of claim 17, further comprising:
determining whether a current coding rate would cause a maximum bucket fullness threshold to be exceeded:
if so, revising coding parameters to reduce the coding rate.

20. The system of claim 17, wherein the network delay period is an estimate rate of change in network delay.

21. The system of claim 17, wherein the output rate is derived from channel statistics.

22. The system of claim 17, wherein the input rate is derived from estimated sizes of coded frames based on a set of coding parameters.

23. The system of claim 17, wherein adjusting the encoder bit rate supports a minimum threshold of quality level of the input video signal.

24. The system of claim 17, wherein adjusting the encoder bit rate comprises adjusting target bits per frame.

25. The system of claim 17, wherein adjusting the encoder bit rate comprises adjusting a frame rate.
